(19) United States
(12) Patent Application Publication
(10) Pub. No.: US 2023/0269029 A1
(43) Pub. Date: Aug. 24, 2023

(54) CONDITIONAL HYBRID AUTOMATIC REPEAT REQUEST (HARQ) ACKNOWLEDGEMENT

(71) Applicant: Nokia Technologies Oy, Espoo (FI)

(72) Inventors: Jeroen WIGARD, Klarup (DK); Frank FREDERIKSEN, Klarup (DK); Mads LAURIDSEN, Gistrup (DK); Rapeepat RATASUK, Inverness, IL (US)

(21) Appl. No.: 18/006,687

(22) PCT Filed: Jul. 14, 2021
(86) PCT No.: PCT/EP2021/069553

§ 371 Date: Jan. 24, 2023

Related U.S. Application Data
(60) Provisional application No. 63/064,722, filed on Aug. 12, 2020.

(51) Int. Cl. H04L 1/08; H04L 5/00; H04L 1/00; H04L 1/1812

(52) U.S. Cl. CPC H04L 1/08; H04L 5/0053; H04L 1/0027; H04L 1/1812

(57) ABSTRACT

Systems, methods, apparatuses, and computer program products for conditional hybrid automatic repeat request (HARQ) acknowledgement (ACK). For instance, a user equipment (UE) may estimate, during reception of a downlink transmission with x repetitions, an amount of extra energy that may be needed to help ensure successful decoding. The UE may then express this estimate as a quantity of repetitions (y) needed for successful reception, and may inform the radio access network (RAN) of this quantity (e.g., at least one round-trip time (RTT) before the last repetition of the x repetitions is sent). The RAN may handle this message as a conditional positive ACK. The RAN may send the quantity of repetitions y, and may implicitly assume an ACK for that TBS after sending the y repetitions. The RAN may send the next transport blocks (TBS) for that HARQ process after completing transmission of they repetitions.

### FIELD

Some example embodiments may generally relate to mobile or wireless telecommunication systems, such as Long Term Evolution (LTE) or fifth generation (5G) radio access technology or new radio (NR) access technology, or other communications systems. For example, certain embodiments may relate to systems and/or methods for conditional hybrid automatic repeat request (HARQ) acknowledgement.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. 5G is mostly built on a new radio (NR), but a 5G (or NG) network can also build on E-UTRA radio. It is estimated that NR may provide bitrates on the order of 10-20 Gbit/s or higher, and may support at least enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. It is noted that, in 5G, the nodes that can provide radio access functionality to a user equipment (i.e., similar to Node B in UTRAN or eNB in LTE) may be named gNB when built on NR radio and may be named NG-eNB when built on E-UTRA radio.

### SUMMARY

According to a first embodiment, a method may include receiving a subset of a plurality of scheduled repetitions of a transport block. The plurality of scheduled repetitions may include one or more remaining scheduled repetitions not included in the subset. The method may include estimating a quantity of remaining repetitions for correct reception of the transport block. The method may include transmitting a message that includes conditional feedback.

In a variant, the conditional feedback may include a negative acknowledgement, a conditional acknowledgement that indicates the quantity of remaining repetitions, or a conditional acknowledgement that indicates a change in an attribute for one or more of the quantity of remaining repetitions. In a variant, the method may further include receiving one or more of the quantity of remaining repetitions when the conditional feedback comprises a conditional acknowledgement. In a variant, the method may further include providing the transport block from a buffer to a processing layer, or flushing the buffer associated with the transport block.

In a variant, the method may further include flushing a buffer when the conditional feedback comprises a negative acknowledgement. In a variant, the transport block may be related to a hybrid automatic repeat request process. In a variant, estimating the quantity of remaining repetitions may further comprise estimating the quantity of remaining repetitions periodically. In a variant, the method may further include determining whether to transmit the conditional feedback based on a configuration of an uplink opportunity or a scheduling gap for the conditional feedback.

In a variant, the conditional feedback may include an indication of a time of transmission of the conditional feedback or a quantity of repetitions included in the received subset when the conditional feedback comprises a conditional acknowledgement. In a variant, the conditional feedback may indicate a quantity of requested repetitions that is equal to or greater than the quantity of remaining repetitions for correct reception of the transport block when the conditional feedback comprises a conditional acknowledgement.

According to a second embodiment, a method may include receiving a subset of a plurality of scheduled repetitions of a transport block. The plurality of scheduled repetitions may include one or more remaining scheduled repetitions not included in the subset. The method may include estimating a quantity of remaining repetitions for correct reception of the transport block. The method may include transmitting a conditional acknowledgement that corresponds to the quantity of remaining repetitions. The method may include receiving one or more of the quantity of remaining repetitions. The method may include providing the transport block from a buffer to a processing layer.

In a variant, the conditional acknowledgement may include a conditional acknowledgement that indicates the quantity of remaining repetitions, or a conditional acknowledgement that indicates a change in an attribute for one or more of the quantity of remaining repetitions. In a variant, the method may further include receiving one or more of the quantity of remaining repetitions. In a variant, the method may further include flushing the buffer associated with the transport block.

In a variant, the transport block may be related to a hybrid automatic repeat request process. In a variant, estimating the quantity of remaining repetitions may further include estimating the quantity of remaining repetitions periodically. In a variant, the method may further comprise determining whether to transmit the conditional acknowledgement based on a configuration of an uplink opportunity or a scheduling gap for the conditional acknowledgement.

In a variant, the conditional acknowledgement may include an indication of a time of transmission of the conditional acknowledgement or a quantity of repetitions included in the received subset. In a variant, the conditional acknowledgement may indicate a quantity of requested repetitions that is equal to or greater than the quantity of remaining repetitions for correct reception of the transport block.

According to a third embodiment, a method may include transmitting a subset of a plurality of scheduled repetitions of a transport block. The plurality of scheduled repetitions may include one or more remaining scheduled repetitions not included in the subset. The method may include receiving a message that includes conditional feedback that corresponds to a quantity of remaining repetitions to be transmitted with respect to the transport block. The method may include adjusting a quantity of the one or more remaining scheduled repetitions based on the quantity of remaining repetitions.

In a variant, the transport block may be related to a hybrid automatic repeat request process. In a variant, the conditional feedback includes an indication of a time of transmission for the conditional feedback or a quantity of repetitions received at a user equipment when the conditional feedback may include a conditional acknowledgement. In a variant, the method may further comprise determining, based on a quantity of transmitted repetitions and a transmission time of the conditional feedback, a quantity of repetitions received at a user equipment when the conditional feedback comprises a conditional acknowledgement.

In a variant, the conditional feedback may indicate the quantity of remaining repetitions equal to or greater than a quantity of remaining scheduled repetitions when the conditional feedback comprises a conditional acknowledgement. In a variant, the method may further include scheduling another subset of another plurality of scheduled repetitions of another transport block based on transmitting one or more of the quantity of remaining repetitions for correct reception of the transport block, and transmitting the other subset of the other plurality of scheduled repetitions based on transmitting the one or more of the quantity of remaining repetitions for correct reception of the transport block. In a variant, the method may further include transmitting a configuration of an uplink opportunity or a scheduling gap for the conditional feedback.

In a variant, adjusting the quantity of the one or more remaining scheduled repetitions may further include adjusting the quantity of the one or more remaining scheduled repetitions to be equal to or greater than the quantity of remaining repetitions indicated in the conditional feedback. In a variant, the method may further include transmitting one or more of the quantity of the one or more remaining scheduled repetitions. In a variant, the method may further include flushing a buffer associated with the transport block.

In a variant, the method may further include receiving a negative acknowledgement as the conditional feedback related to one or more of the quantity of remaining repetitions for correct reception, and determining to not transmit the one or more of the quantity of remaining repetitions for correct reception. In a variant, the method may further include adjusting an attribute for the quantity of remaining repetitions. In a variant, the quantity of remaining repetitions may be zero when the conditional feedback comprises a conditional acknowledgement, or the quantity of remaining repetitions may be a positive integer when the conditional feedback comprises a negative acknowledgement.

A fourth embodiment may be directed to an apparatus including at least one processor and at least one memory comprising computer program code. The at least one memory and computer program code may be configured, with the at least one processor, to cause the apparatus at least to perform the method according to the first embodiment, the second embodiment, or the third embodiment, or any of the variants discussed above.

A fifth embodiment may be directed to an apparatus that may include circuitry configured to perform the method according to the first embodiment, the second embodiment, or the third embodiment, or any of the variants discussed above.

A sixth embodiment may be directed to an apparatus that may include means for performing the method according to the first embodiment, the second embodiment, or the third embodiment, or any of the variants discussed above. Examples of the means may include one or more processors, memory, and/or computer program codes for causing the performance of the operation.

A seventh embodiment may be directed to a computer readable medium comprising program instructions stored thereon for performing at least the method according to the first embodiment, the second embodiment, or the third embodiment, or any of the variants discussed above.

An eighth embodiment may be directed to a computer program product encoding instructions for performing at least the method according to the first embodiment, the second embodiment, or the third embodiment, or any of the variants discussed above.

### BRIEF DESCRIPTION OF THE DRAWINGS

For proper understanding of example embodiments, reference should be made to the accompanying drawings, wherein:

FIG. 1 illustrates an example of conditional HARQ acknowledgement, according to some embodiments;

FIG. 2 illustrates a flow chart of an example method implemented by a UE, according to some embodiments;

FIG. 3 illustrates a flow chart of an example method implemented by a network node, according to some embodiments;

FIG. 4 illustrates an example of uplink signaling, according to some embodiments;

FIG. 5 illustrates an example flow diagram of a method, according to some embodiments;

FIG. 6 illustrates an example flow diagram of a method, according to some embodiments;

FIG. 7 illustrates an example flow diagram of a method, according to some embodiments;

FIG. 8a illustrates an example block diagram of an apparatus, according to an embodiment; and

FIG. 8b illustrates an example block diagram of an apparatus, according to another embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for conditional HARQ acknowledgement is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments. In addition, the phrase “set of” refers to a set that includes one or more of the referenced set members. As such, the phrases “set of,” “one or more of,” and “at least one of,” or equivalent phrases, may be used interchangeably. Further, “or” is intended to mean “and/or,” unless explicitly stated otherwise.

Additionally, if desired, the different functions or operations discussed below may be performed in a different order and/or concurrently with each other. Furthermore, if desired, one or more of the described functions or operations may be optional or may be combined. As such, the following description should be considered as merely illustrative of the principles and teachings of certain example embodiments, and not in limitation thereof.

NR may provide 5G NR service to users on Earth, for example, through low-Earth orbit (LEO), geostationary earth orbit (GEO) satellites, and high altitude platform system (HAPS). Certain challenges with respect to these operations may include poor link budget. The link budget from a transmission point high in the sky may be poor, especially for GEO satellites and considering Internet of Things (IoT) devices may have simple antennas and receivers. In addition, there may be large delays, which may lead to large round-trip time (RTT), which means that feedback loops may become slow.

Narrowband (NB)-IoT may be used for infrequent and short messages between the UE and the network. NB-IoT may be used for low-power wide-area terrestrial networks with targets of very long range (20 decibels (dB) better than global system for mobile communication (GSM)) and low device power consumption (e.g., 10 years battery lifetime) with a maximum communication delay of 10 seconds (s).

One possible way to achieve the long range may include use of repetitions of an encoded payload to ensure sufficient energy is obtained in the receiver. NB-IoT may allow for excessive repetitions (e.g., up to 2,048 repetitions in downlink and up to 128 repetitions in uplink). A mobility management entity (MME) may configure up to 3 coverage enhancement (CE) levels (CE level 0 to CE level 2). One impact of the different CE levels may be that the messages may have to be repeated several times depending upon UE location (for the current CE level). The number of repetitions may be enhanced further in non-terrestrial network (NTN) context to deal with link budget issues. Another challenge of NTN may include long propagation delays.

Based on this, the time between the UE sending an acknowledgement (ACK)/negative ACK (NACK) and the radio area network (RAN) receiving the ACK/NACK may be considerably longer than in terrestrial networks. This can lead to stalling as the network cannot transmit the next transport blocks (TBS) for the relevant HARQ process before the network can determine whether the previous transport block was correctly received. This stalling probability may be further increased because as NB-IoT devices may have to be cheap, they may be configured to have a limited number of HARQ processes with a minimum of 1 HARQ process. For example, IoT devices may have a limited number of HARQ processes to save cost (e.g., NB-IoT UEs may support either 1 or 2 HARQ processes depending on UE capability).

At the same time the round-trip time (RTT) in NTN can be rather large, as explained above. Stalling of data transmissions to a UE may occur due to one or more of long transmission time, a low number of HARQ processes, and long feedback delays. For example, stalling may occur due to the time to fill a HARQ process being shorter than the RTT. For example, when the RTT is 20 milliseconds (ms), the efficiency may be reduced to 20 percent with 4 HARQ processes and to 5 percent with 1 HARQ process. Based on this, a data transmission may take a longer time, causing the UE to stay awake longer, to experience a lower throughput, and/or to consume more power than otherwise needed.

Some embodiments described herein may provide for conditional HARQ acknowledgement (e.g., in situations where there is a large number of repetitions, such as in NTN when link budget is poor). For instance, a UE may estimate, during reception of a downlink transmission with x repetitions, an amount of extra energy that may be needed to help ensure successful decoding. The UE may then express this estimate as a quantity of repetitions (y) needed for successful reception, and may inform the RAN (e.g., one or more network nodes) of this quantity (e.g., at least one RTT before the last repetition of the x repetitions is sent). The RAN may handle this message as a conditional positive ACK. The RAN may send the quantity of repetitions y, and may implicitly assume an ACK for that transport block after sending the y repetitions (e.g., the RAN may not need to wait for an ACK from the UE after completing the transmission of they repetitions). The RAN may send the next transport block for that HARQ process after completing transmission of the y repetitions and based on implicitly assuming the ACK. In this way, certain embodiments described herein may reduce or eliminate the stalling issues described, which may conserve computing resources of a UE that would otherwise be consumed as a result of stalling. In addition, this may increase a throughput of the UE, thereby improving an operating performance of the UE.

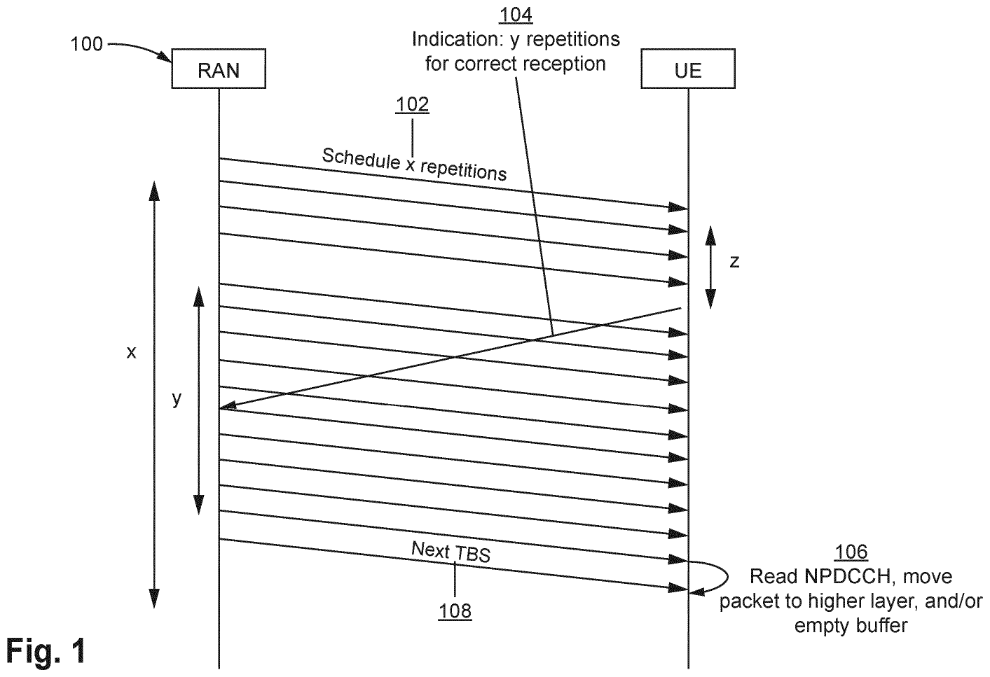

FIG. 1 illustrates an example 100 of conditional HARQ acknowledgement, according to some embodiments. The example 100 of FIG. 1 illustrates a RAN, which may comprise one or more network nodes, and a UE. As illustrated at 102, the RAN may schedule x repetitions of a transport block to the UE. The RAN may transmit, and the UE may receive a quantity z of the scheduled x repetitions. After receiving the z repetitions, the UE may transmit, and the RAN may receive, conditional feedback. For example, the conditional feedback may include a conditional ACK or a NACK. The conditional feedback of the example of FIG. 1 may include a conditional ACK that includes an indication of a quantity of repetitions y that may be needed for correct reception (e.g., successful decoding) of the transport block, at 104. In some embodiments, the UE may transmit a NACK instead of the conditional ACK, or at a time after transmitting the conditional ACK but before reception of the y repetitions is complete. The NACK may cause the RAN to stop transmitting repetitions for the transport block. Alternately, the NACK may cause the RAN to transmit additional repetitions for the transport block.

During estimation of y and after transmitting the indication, the UE may receive one or more of the x repetitions. Based on the indication of y from the UE, the RAN may adjust a total quantity of repetitions to be transmitted for the transport block based on they quantity of repetitions. Specifically, the RAN may determine the total quantity of repetitions to transmit as equaling a total of z+y repetitions. By the time the RAN receives the indication of y repetitions, an amount of time may have elapsed (as illustrated in FIG. 1). During this elapsed time, the RAN may transmit one or more repetitions. Based on this, the RAN may account for the one or more transmissions that the RAN has transmitted during the time between when the UE sent the indication of y and when the RAN received the indication of y by transmitting less than the quantity y repetitions after receiving the indication of y so that the total quantity of repetitions that the RAN transmits is equal to z+y.

As illustrated, the RAN may transmit, and the UE may receive, the quantity of remaining repetitions. As illustrated at 106, after receiving the quantity of remaining repetitions, the UE may read a narrowband physical downlink control channel (NPDCCH). Additionally, or alternatively, the UE may move the packet associated with the transport block to a higher processing layer of an application of the UE. For example, the UE may receive the repetitions in a buffer (e.g., a physical layer buffer, such as a layer 1 (L1) buffer), and the UE may move the received data from the buffer to a medium access control (MAC) processing layer, then to radio link control (RLC) processing layer, then to a packet data convergence protocol (PDCP) processing layer, etc. (e.g., where each layer has a header and various protocols for handling the packet). Additionally, or alternatively, the UE may empty the buffer, such as by flushing the buffer. As illustrated at 108, after receiving the last remaining repetition for the transport block, the UE may start to receive repetitions for one or more next TBS.

In some embodiments, after sending the conditional ACK at a first time, the UE may switch, at a second time, from receiving the transport block on the narrowband physical downlink shared channel (NPDSCH) to monitoring the NPDCCH for scheduling information of the next transport block. The second time may be based on the conditional ACK message and the RTT (e.g., based on the quantity y indicated in the conditional ACK and the RTT).

As described above, FIG. 1 is provided as an example. Other examples are possible, according to some embodiments.

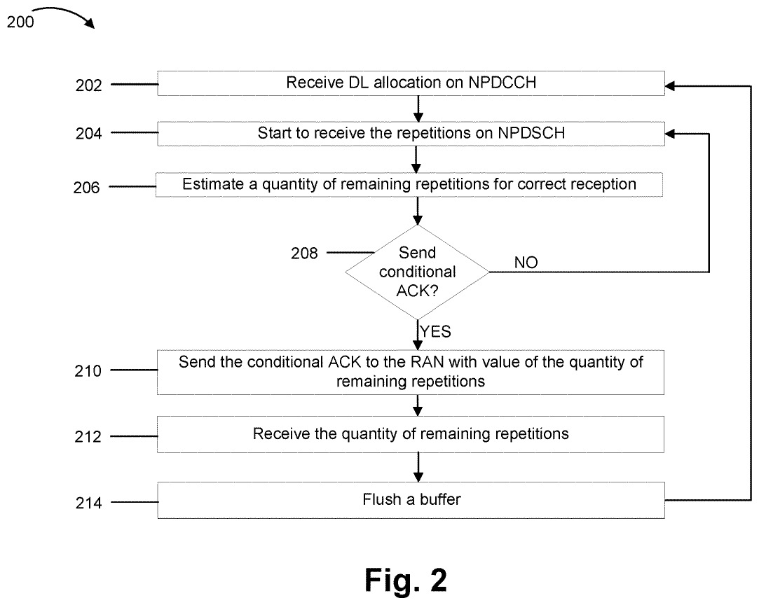

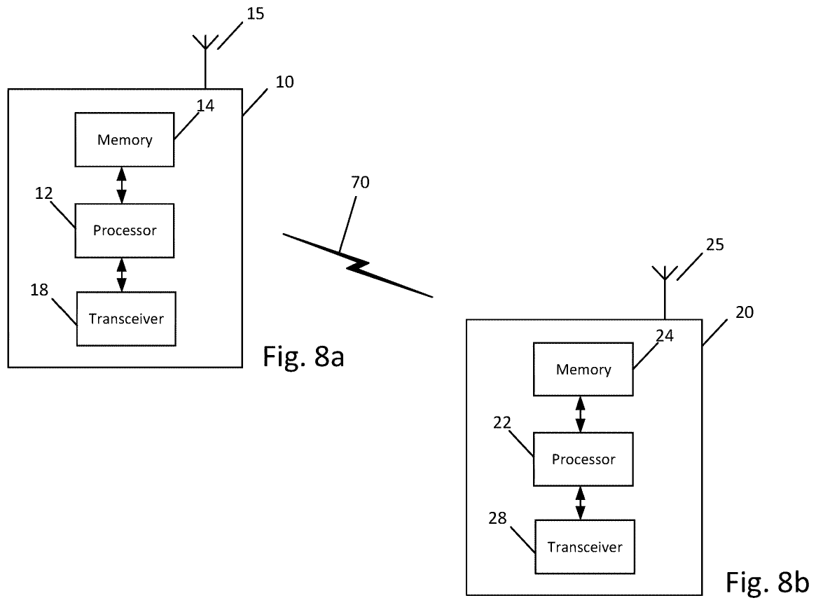

FIG. 2 illustrates a flow chart of an example method 200 implemented by a UE, according to some embodiments. For example, the UE may be an apparatus 10 illustrated in, and described with respect to, FIG. 8a.

As illustrated at 202, the UE may receive downlink (DL) allocation on NPDCCH of repetitions for a transport block. For example, the DL allocation may schedule the x repetitions associated with a HARQ process.

As illustrated at 204, the UE may start to receive the repetitions on NPDSCH. For example, the UE may receive a subset z of the x repetitions. As illustrated at 206, during the reception of the repetitions, the UE may estimate a quantity of remaining repetitions for correct reception of the transport block. For example, the UE may estimate a quantity of remaining repetitions y that may be needed to correctly receive the transport block. In some embodiments, the UE may estimate, at intervals during reception of repetitions, the quantity of remaining repetitions for correct reception. The intervals can be every repetition or every n-th repetition depending on the received repetition number, prior to a scheduling gap, after a certain number of repetitions have been received, and/or the like.

As illustrated at 208, the UE may determine whether to send a conditional ACK. For example, the UE may determine if it is time to send the conditional ACK. This may depend on the actual RTT, the quantity of scheduled repetitions or the quantity of remaining repetitions y, or may be based on a transmission gap set by the network. If the UE determines to not send the conditional ACK (208—NO), then the UE may return to performing the operations illustrated at 204. If the UE determines to send the conditional ACK (208—YES), then the UE may, at 210, send the conditional ACK to the RAN with a value of the quantity of remaining repetitions. For example, if it is time for the UE to send the conditional ACK, the UE may send a conditional ACK that indicates the quantity of remaining repetitions y from that point in time. In certain embodiments, the signaling by the UE may include an indication of the time that the conditional ACK is sent or the current number of received repetitions z.

As illustrated at 212, the UE may receive the quantity of remaining repetitions. For example, the UE may receive the y repetitions after transmitting the conditional ACK, so the total quantity of repetitions received at the UE is y+z. As illustrated at 214, the UE may flush a buffer that was used to receive the repetitions. In certain embodiments, the UE may move the packet to a higher processing layer and/or may expect one or more next TBS.

In some embodiments, the UE may send a NACK with respect to the example of FIG. 2 (e.g., the NACK may cause the RAN to stop transmitting repetitions). For example, the UE may, at 208, determine whether to send the NACK in connection with, or rather than, determining whether to send the ACK, and may send the NACK rather than sending the ACK. In this case, the UE may not perform the operations at 210 and/or 212 based on sending the NACK. Alternatively, the UE may determine to send the NACK during the operations at 212, which may cause the UE to receive less than the quantity of remaining repetitions y. After sending the NACK, the UE may perform the operations at 214.

As indicated above, FIG. 2 is provided as an example. Other examples are possible, according to some embodiments.

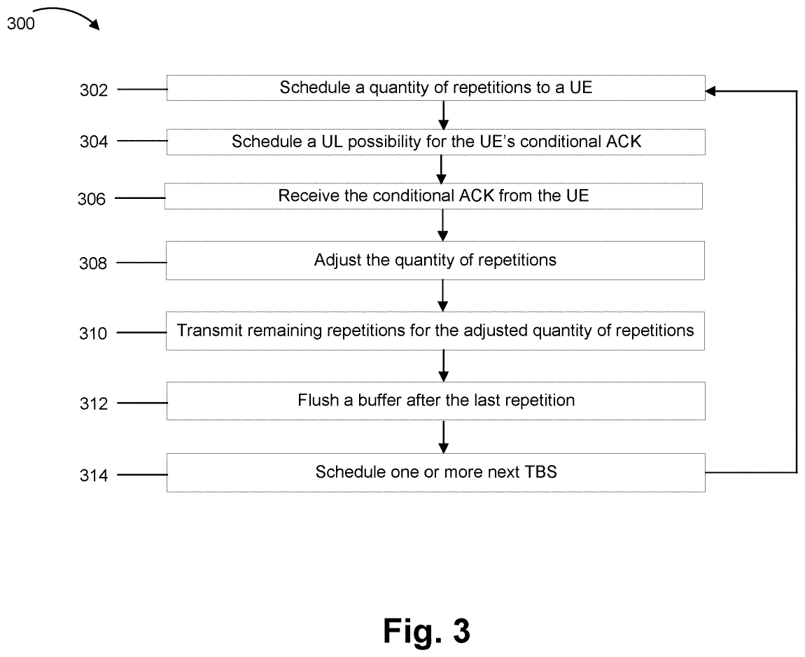

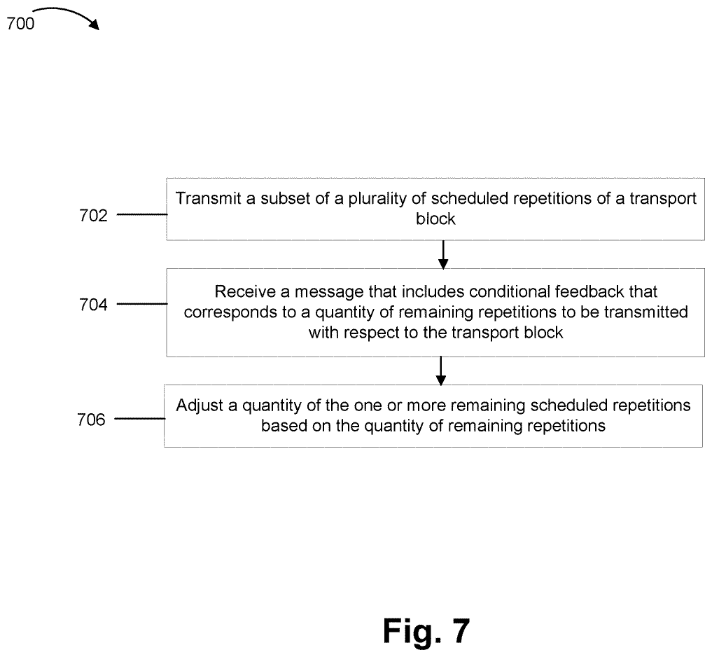

FIG. 3 illustrates a flow chart of an example method 300 implemented by a network node of a RAN, according to some embodiments. For example, the network node may be an apparatus 20 illustrated in, and described with respect to, FIG. 7b.

As illustrated at 302, the network node may schedule a quantity of repetitions to a UE. For example, the network node may schedule x repetitions to the UE, where the x repetitions may belong to a HARQ process. As illustrated at 304, the network node may schedule an uplink (UL) possibility for the UE's conditional ACK. For example, the RAN may configure an uplink opportunity or a scheduling gap for the UE to send the conditional ACK. Alternately, the uplink opportunity or scheduling gap may be pre-defined at the UE.

As illustrated at 306, the network node may receive the conditional ACK from the UE. For example, the network node may receive the conditional ACK indicating the value of y described elsewhere herein. Additionally, or alternatively, the conditional ACK may include an indication of the time that the UE transmitted the conditional ACK or the current quantity of received repetitions z that the UE has received. In certain embodiments, the network node may calculate the quantity of repetitions sent after the z repetitions based on the transmission or reception time of the conditional ACK (e.g., to allow the UE to estimate the UE's transmission time based on information regarding reception time and/or propagation delay).

As illustrated at 308, the network node may adjust the quantity of repetitions. For example, the network node may adjust the quantity of repetitions to reflect the value of y. The network node may adjust the quantity such that z+y repetitions are sent in total. In some embodiments, the network node may perform one or more other adjustments, such as an adjustment to transmission power for the repetitions, transmission timing for the repetitions, and/or the like. As illustrated at 310, the network node may transmit remaining repetitions for the adjusted quantity of repetitions. For example, the network node may transmit repetitions until z+y repetitions are transmitted. In certain embodiments, the network node may receive a NACK from the UE rather than the conditional ACK, where the NACK is associated with causing the network node to stop transmitting repetitions. Based on reception of the NACK, the network node may adjust the quantity of repetitions to zero to stop the transmission of additional repetitions.

As illustrated at 312, the network node may flush a buffer after the last repetition is transmitted. For example, the network node may flush the buffer without receiving an ACK indicating that the transport block was correctly received. In this way, the network node may assume, based on transmitting z+y repetitions that the transport block was successfully received at the UE, and signaling that would otherwise be used to indicate successful reception of the transport block to the network node can be eliminated. This may conserve computing resources of the UE and the network node, and may conserve network resources, such as bandwidth. As illustrated at 314, the network node may schedule one or more next TBS. After scheduling the one or more next TBS, the network node may return to performing operations at 302.

As described above, FIG. 3 is provided as an example. Other examples are possible, according to some embodiments.

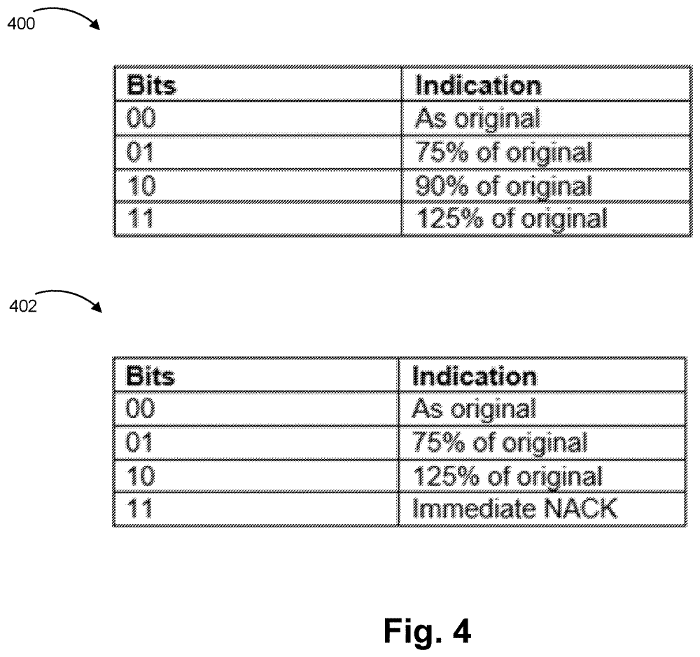

FIG. 4 illustrates an example of uplink signaling, according to some embodiments. For example, FIG. 4 illustrates example mappings 400 and 402 between bits of the conditional feedback signaling and the indication provided by the bits.

As explained above, because the uplink link budget may be limited, the signalling space for indications described herein may be limited. Because of this, the number of bits to signal the value of y may be limited. If the number of bits is not limited, then the exact value of y may be indicated. In the example mappings 400 and 402 for uplink signalling, two bits may be used. The two bits may be used to indicate the value of y based on the original number of scheduled repetitions x. The percentages to be indicated by the bits may be broadcasted by the RAN, or dedicated signalling may be used (which may allow for differentiated values per UE). In both mappings 400, 402, the combination 00 may be used to indicate a planned quantity of repetitions for assuming an ACK. This may provide an advantage of the network being able to assume an ACK after sending the repetitions, which reduces latency that would otherwise occur waiting for an ACK from the UE.

In this way, the conditional feedback may indicate a quantity of requested repetitions (e.g., a percentage of the originally scheduled plurality of repetitions to be transmitted) that is equal to or greater than the quantity of remaining repetitions for correct reception of the transport block. For example, the indication in the conditional feedback may be based on the plurality of scheduled repetitions x for the transport block, where the indication of y repetitions may be a larger or smaller quantity than x Due to signaling limitations (e.g., the number of available bits), it may not be possible to directly indicate the quantity y, and an approximation of y may be indicated. In certain embodiments, this approximation may be equal to or greater than the quantity y. If the network sends less than y repetitions, the transport block decoding may fail.

From the mappings 400, 402, it is illustrated that the original number of scheduled repetitions from the RAN can be made larger or smaller. In the mapping 402, there may the option of indicating a NACK. Based on reception of the NACK, the RAN may stop the repetitions. This can be used for instance, if the quantity of repetitions is larger than a threshold (e.g., in NTN, the time in a cell may be limited (e.g., 6-10 s) as LEO satellites can move fast across the sky and there may not be enough time in the cell for more than a certain quantity of repetitions).

In addition to defining the content of the uplink signalling, the UE may perform the uplink signalling at certain times. For instance, if UE is capable of providing the conditional ACK, the network node may schedule one or more opportunities to transmit the conditional ACK. From a signalling perspective, an uplink transmission opportunity can be configured when signalling the downlink scheduling or by pre-defining when conditional ACK transmission opportunities are available based on the quantity of repetitions and/or the RTT. If a network entity receives, at multiple different occasions, conditional ACKs that indicate a percentage of the x repetitions that may be needed, the network node may adjust its resource allocation (quantity of repetitions) to be more freely distributed. This may impact the configuration of the signalling bits in the mappings 400, 402. For example, if x becomes low enough that it is not feasible to signal a percentage of the scheduled repetitions within a reasonable receiving time, the network node may reconfigure or disable the use of the conditional ACK.

As described above, FIG. 4 is provided as an example. Other examples are possible, according to some embodiments.

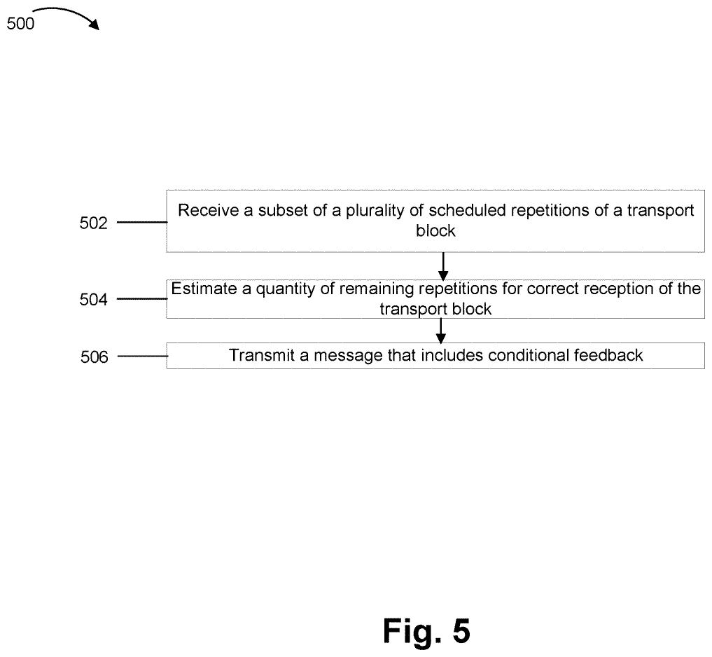

FIG. 5 illustrates an example flow diagram of a method 500, according to some embodiments. For example, FIG. 5 shows example operations of a UE (e.g., apparatus 20 illustrated in, and described with respect to, FIG. 8a). Some of the operations illustrated in FIG. 5 may be similar to some operations shown in, and described with respect to, FIGS. 1-4.

In an embodiment, the method may include, at 502, receiving a subset of a plurality of scheduled repetitions of a transport block, for example, in a manner similar to that described at 204 of FIG. 2. The plurality of scheduled repetitions may include one or more remaining scheduled repetitions not included in the subset. The method may include, at 504, estimating a quantity of remaining repetitions for correct reception of the transport block, for example, in a manner similar to that described at 206 of FIG. 2. The method may include, at 506, transmitting a message that includes conditional feedback.

The UE may perform one or more other operations in connection with the method illustrated in FIG. 5. In some embodiments, the conditional feedback may include a negative acknowledgement, a conditional acknowledgement that indicates the quantity of remaining repetitions, or a conditional acknowledgement that indicates a change in an attribute (e.g., transmission power, quantity, and/or the like) for one or more of the quantity of remaining repetitions. In some embodiments, the method may further include receiving one or more of the quantity of remaining repetitions when the conditional feedback includes a conditional acknowledgement. In some embodiments, the method may further include providing the transport block from a buffer to a processing layer (e.g., a higher processing layer), or flushing the buffer associated with the transport block.

In some embodiments, the method may further include flushing a buffer when the conditional feedback includes a negative acknowledgement and not providing received repetitions to a processing layer. In some embodiments, the transport block may be related to a hybrid automatic repeat request process. In some embodiments, estimating the quantity of remaining repetitions may further include estimating the quantity of remaining repetitions periodically. In some embodiments, the method may further include determining whether to transmit the conditional feedback based on a configuration of an uplink opportunity or a scheduling gap for the conditional feedback. In some embodiments, the conditional feedback may include an indication of a time of transmission of the conditional feedback or a quantity of repetitions included in the received subset when the conditional feedback includes a conditional acknowledgement. In some embodiments, the conditional feedback may indicate a quantity of requested repetitions that is equal to or greater than the quantity of remaining repetitions for correct reception of the transport block when the conditional feedback includes a conditional acknowledgement.

As described above, FIG. 5 is provided as an example. Other examples are possible according to some embodiments.

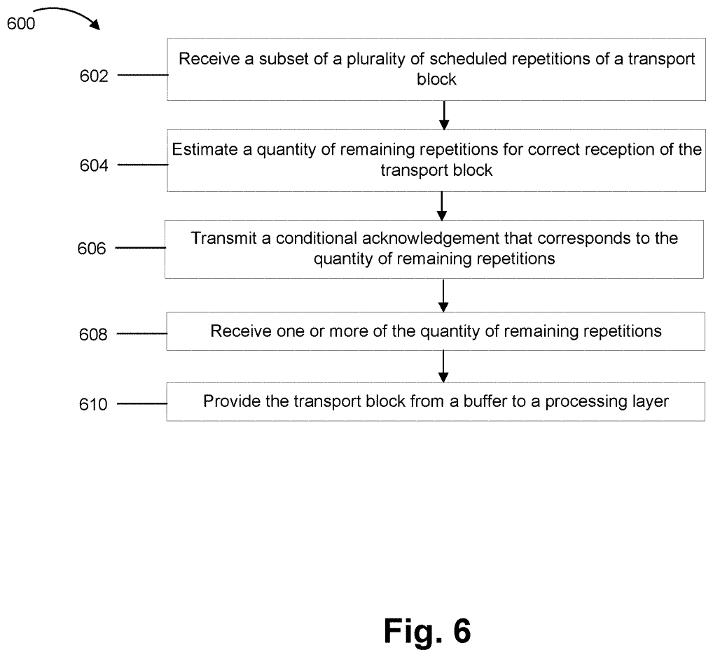

FIG. 6 illustrates an example flow diagram of a method 600, according to some embodiments. For example, FIG. 6 shows example operations of a UE (e.g., apparatus 20 illustrated in, and described with respect to, FIG. 8a). Some of the operations illustrated in FIG. 6 may be similar to some operations shown in, and described with respect to, FIGS. 1-4.

In an embodiment, the method may include, at 602, receiving a subset of a plurality of scheduled repetitions of a transport block, for example, in a manner similar to that described at 204 of FIG. 2. The plurality of scheduled repetitions may include one or more remaining scheduled repetitions not included in the subset. The method may include, at 604, estimating a quantity of remaining repetitions for correct reception of the transport block, for example, in a manner similar to that described at 206 of FIG. 2. The method may include, at 606, transmitting a conditional acknowledgement that corresponds to the quantity of remaining repetitions, for example, in a manner similar to that described at 210 of FIG. 2. The method may include, at 608, receiving one or more of the quantity of remaining repetitions, for example, in a manner similar to that described at 212 of FIG. 2. The method may include, at 610, providing the transport block from a buffer to a processing layer.

The UE may perform one or more other operations in connection with the method illustrated in FIG. 6. In some embodiments, the conditional acknowledgement may include a conditional acknowledgement that indicates the quantity of remaining repetitions, or a conditional acknowledgement that indicates a change in an attribute for one or more of the quantity of remaining repetitions. In some embodiments, the method may further include receiving one or more of the quantity of remaining repetitions. In some embodiments, the method may include flushing the buffer associated with the transport block.

In some embodiments, the transport block may be related to a hybrid automatic repeat request process. In some embodiments, estimating the quantity of remaining repetitions may further include estimating the quantity of remaining repetitions periodically. In some embodiments, the method may further include determining whether to transmit the conditional acknowledgement based on a configuration of an uplink opportunity or a scheduling gap for the conditional acknowledgement. In some embodiments, the conditional acknowledgement may include an indication of a time of transmission of the conditional acknowledgement or a quantity of repetitions included in the received subset. In some embodiments, the conditional acknowledgement may indicate a quantity of requested repetitions that is equal to or greater than the quantity of remaining repetitions for correct reception of the transport block.

As described above, FIG. 6 is provided as an example. Other examples are possible according to some embodiments.

FIG. 7 illustrates an example flow diagram of a method 700, according to some embodiments. For example, FIG. 7 shows example operations of a network node (e.g., apparatus 10 illustrated in, and described with respect to, FIG. 8b). Some of the operations illustrated in FIG. 7 may be similar to some operations shown in, and described with respect to, FIGS. 1-4.

In an embodiment, the method may include, at 702, transmitting a subset of a plurality of scheduled repetitions of a transport block. The plurality of scheduled repetitions may include one or more remaining scheduled repetitions not included in the subset. The method may include, at 704, receiving a message that includes conditional feedback that corresponds to a quantity of remaining repetitions to be transmitted with respect to the transport block, for example, in a manner similar to that described at 306 of FIG. 3. The method may include, at 706, adjusting a quantity of the one or more remaining scheduled repetitions based on the quantity of remaining repetitions, for example, in a manner similar to that described at 308 of FIG. 3.

The network node may perform one or more other operations in connection with the method illustrated in FIG. 7. In some embodiments, the transport block may be related to a hybrid automatic repeat request process. In some embodiments, the conditional feedback may include an indication of a time of transmission for the conditional feedback or a quantity of repetitions received at a user equipment when the conditional feedback includes a conditional acknowledgement. In some embodiments, the method may include determining, based on a quantity of transmitted repetitions and a transmission time of the conditional feedback, a quantity of repetitions received at a user equipment when the conditional feedback includes a conditional acknowledgement.

In some embodiments, the conditional feedback may indicate the quantity of remaining repetitions equal to or greater than a quantity of remaining scheduled repetitions when the conditional feedback comprises a conditional acknowledgement. In some embodiments, the method may further include scheduling another subset of another plurality of scheduled repetitions of another transport block based on transmitting one or more of the quantity of remaining repetitions for correct reception of the transport block, and transmitting the other subset of the other plurality of scheduled repetitions based on transmitting the one or more of the quantity of remaining repetitions for correct reception of the transport block. In some embodiments, the method may include transmitting a configuration of an uplink opportunity or a scheduling gap for the conditional feedback.

In some embodiments, adjusting the quantity of the one or more remaining scheduled repetitions may further include adjusting the quantity of the one or more remaining scheduled repetitions to be equal to or greater than the quantity of remaining repetitions indicated in the conditional feedback. In some embodiments, the method may further include transmitting one or more of the quantity of the one or more remaining scheduled repetitions. In some embodiments, the method may further include flushing a buffer associated with the transport block.

In some embodiments, the method may further include receiving a negative acknowledgement as the conditional feedback related to one or more of the quantity of remaining repetitions for correct reception, and determining to not transmit the one or more of the quantity of remaining repetitions for correct reception. In some embodiments, the method may further include adjusting an attribute for the quantity of remaining repetitions. In some embodiments, the quantity of remaining repetitions may be zero when the conditional feedback includes a conditional acknowledgement, or the quantity of remaining repetitions is a positive integer when the conditional feedback includes a negative acknowledgement.

As described above, FIG. 7 is provided as an example. Other examples are possible according to some embodiments.

FIG. 8a illustrates an example of an apparatus 10 according to an embodiment. In an embodiment, apparatus 10 may be a node, host, or server in a communications network or serving such a network. For example, apparatus 10 may be a network node, satellite, base station, a Node B, an evolved Node B (eNB), 5G Node B or access point, next generation Node B (NG-NB or gNB), and/or a WLAN access point, associated with a radio access network, such as a LTE network, 5G or NR. In some example embodiments, apparatus 10 may be an eNB in LTE or gNB in 5G.

It should be understood that, in some example embodiments, apparatus 10 may be comprised of an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a front-haul interface. The DU may be a logical node that includes a subset of the gNB functions, depending on the functional split option. It should be noted that one of ordinary skill in the art would understand that apparatus 10 may include components or features not shown in FIG. 8a.

As illustrated in the example of FIG. 8a, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 8a, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication or communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device).

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry or control circuitry. In addition, in some embodiments, transceiver 18 may be included in or may form a part of transceiver circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to case an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be a network node or RAN node, such as a base station, access point, Node B, eNB, gNB, WLAN access point, or the like.

According to certain embodiments, apparatus 10 may be controlled by memory 14 and processor 12 to perform the functions associated with any of the embodiments described herein, such as some operations illustrated in, or described with respect to, FIGS. 1-4 and 7. For instance, apparatus 10 may be controlled by memory 14 and processor 12 to perform the method of FIG. 7.

FIG. 8b illustrates an example of an apparatus 20 according to another embodiment. In an embodiment, apparatus 20 may be a node or element in a communications network or associated with such a network, such as a UE, mobile equipment (ME), mobile station, mobile device, stationary device, IoT device, or other device. As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 8b.

As illustrated in the example of FIG. 8b, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 8b, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry. As discussed above, according to some embodiments, apparatus 20 may be a UE, mobile device, mobile station, ME, IoT device and/or NB-IoT device, for example. According to certain embodiments, apparatus 20 may be controlled by memory 24 and processor 22 to perform the functions associated with any of the embodiments described herein, such as some operations illustrated, or described with respect to, in FIGS. 1-6. For instance, in one embodiment, apparatus 20 may be controlled by memory 24 and processor 22 to perform the methods of FIGS. 5 and 6.

In some embodiments, an apparatus (e.g., apparatus 10 and/or apparatus 20) may include means for performing a method or any of the variants discussed herein, e.g., a method described with reference to FIGS. 5-7. Examples of the means may include one or more processors, memory, and/or computer program codes for causing the performance of the operation.

Therefore, certain example embodiments provide several technological improvements, enhancements, and/or advantages over existing technological processes. For example, benefits of some example embodiments are reduced occurrence of stalling, lower power consumption, and/or higher throughput. Accordingly, the use of some example embodiments results in improved functioning of communications networks and their nodes and, therefore constitute an improvement at least to the technological field of reception of transport blocks, among others.

Although certain embodiments have been described in the context of NB-IoT, certain embodiments described herein may apply to any radio access technology where long RTT and/or repetitions may be used.

In some example embodiments, the functionality of any of the methods, processes, signaling diagrams, algorithms or flow charts described herein may be implemented by software and/or computer program code or portions of code stored in memory or other computer readable or tangible media, and executed by a processor.

In some example embodiments, an apparatus may be included or be associated with at least one software application, module, unit or entity configured as arithmetic operation(s), or as a program or portions of it (including an added or updated software routine), executed by at least one operation processor. Programs, also called program products or computer programs, including software routines, applets and macros, may be stored in any apparatus-readable data storage medium and may include program instructions to perform particular tasks.

A computer program product may include one or more computer-executable components which, when the program is run, are configured to carry out some example embodiments. The one or more computer-executable components may be at least one software code or portions of code. Modifications and configurations used for implementing functionality of an example embodiment may be performed as routine(s), which may be implemented as added or updated software routine(s). In one example, software routine(s) may be downloaded into the apparatus.

As an example, software or a computer program code or portions of code may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, such as a non-tangible means that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein apply equally to both singular and plural implementations, regardless of whether singular or plural language is used in connection with describing certain embodiments. For example, an embodiment that describes operations of a single network node equally applies to embodiments that include multiple instances of the network node, and vice versa.

One having ordinary skill in the art will readily understand that the example embodiments as discussed above may be practiced with operations in a different order, and/or with hardware elements in configurations which are different than those which are disclosed. Therefore, although some embodiments have been described based upon these example preferred embodiments, it would be apparent to those of skill in the art that certain modifications, variations, and alternative constructions would be apparent, while remaining within the spirit and scope of example embodiments.

### PARTIAL GLOSSARY

ACK Acknowledgement
NACK Negative Acknowledgement
RAN Radio Access Network
RTT Round-Trip Time
TBS Transport Blocks
UE User Equipment

1. A method, comprising:
receiving, by a user equipment, a subset of a plurality of scheduled repetitions of a transport block, wherein the plurality of scheduled repetitions includes one or more remaining scheduled repetitions not included in the subset;
estimating a quantity of remaining repetitions for correct reception of the transport block; and
transmitting a message that includes conditional feedback.

2. The method according to claim 1, wherein the conditional feedback comprises:
a negative acknowledgement,
a conditional acknowledgement that indicates the quantity of remaining repetitions, or
a conditional acknowledgement that indicates a change in an attribute for one or more of the quantity of remaining repetitions.

3. The method according to claim 1, further comprising:
receiving one or more of the quantity of remaining repetitions when the conditional feedback comprises a conditional acknowledgement.

4. The method according to claim 3, further comprising:
providing the transport block from a buffer to a processing layer, or
flushing the buffer associated with the transport block.

5. The method according to claim 1, further comprising:
flushing a buffer when the conditional feedback comprises a negative acknowledgement.

6. The method according to claim 1, wherein the transport block is related to a hybrid automatic repeat request process.

7. The method according to claim 1, wherein estimating the quantity of remaining repetitions further comprises:
estimating the quantity of remaining repetitions periodically.

8. The method according to claim 1, further comprising:
determining whether to transmit the conditional feedback based on a configuration of an uplink opportunity or a scheduling gap for the conditional feedback.

9. The method according to claim 1, wherein the conditional feedback includes an indication of a time of transmission of the conditional feedback or a quantity of repetitions included in the received subset when the conditional feedback comprises a conditional acknowledgement.

10. The method according to claim 1, wherein the conditional feedback indicates a quantity of requested repetitions that is equal to or greater than the quantity of remaining repetitions for correct reception of the transport block when the conditional feedback comprises a conditional acknowledgement.

11. A method, comprising:
receiving, by a user equipment, a subset of a plurality of scheduled repetitions of a transport block, wherein the plurality of scheduled repetitions includes one or more remaining scheduled repetitions not included in the subset;
estimating a quantity of remaining repetitions for correct reception of the transport block;
transmitting a conditional acknowledgement that corresponds to the quantity of remaining repetitions;
receiving one or more of the quantity of remaining repetitions; and
providing the transport block from a buffer to a processing layer.

12. The method according to claim 11, wherein the conditional acknowledgement comprises:
a conditional acknowledgement that indicates the quantity of remaining repetitions, or
a conditional acknowledgement that indicates a change in an attribute for one or more of the quantity of remaining repetitions.

13. The method according to claim 11, further comprising:
receiving one or more of the quantity of remaining repetitions.

14. The method according to claim 11, further comprising:
flushing the buffer associated with the transport block.

15. The method according to claim 11, wherein the transport block is related to a hybrid automatic repeat request process.

16. The method according to claim 11, wherein estimating the quantity of remaining repetitions further comprises:
estimating the quantity of remaining repetitions periodically.

17. The method according to claim 11, further comprising:
determining whether to transmit the conditional acknowledgement based on a configuration of an uplink opportunity or a scheduling gap for the conditional acknowledgement.

18. The method according to claim 11, wherein the conditional acknowledgement includes an indication of a time of transmission of the conditional acknowledgement or a quantity of repetitions included in the received subset.

19. The method according to claim 11, wherein the conditional acknowledgement indicates a quantity of requested repetitions that is equal to or greater than the quantity of remaining repetitions for correct reception of the transport block.

20. A method, comprising:
transmitting, by a network node, a subset of a plurality of scheduled repetitions of a transport block, wherein the plurality of scheduled repetitions includes one or more remaining scheduled repetitions not included in the subset;
receiving a message that includes conditional feedback that corresponds to a quantity of remaining repetitions to be transmitted with respect to the transport block; and
adjusting a quantity of the one or more remaining scheduled repetitions based on the quantity of remaining repetitions.

21-37. (canceled)
